(19) United States
(12) Patent Application Publication
(10) Pub. No.: US 2023/0370835 A1
(43) Pub. Date: Nov. 16, 2023

(54) CONFIGURING MOBILE DEVICE FOR WIRELESS SERVICE PROVIDER

(71) Applicant: DISH Wireless L.L.C., Englewood, CO (US)

(72) Inventors: Kantha Kumar Kanchiraju, Overland Park, KS (US); Robert Urbanek, Overland Park, KS (US)

(21) Appl. No.: 18/195,833

(22) Filed: May 10, 2023

Related U.S. Application Data
(60) Provisional application No. 63/340,221, filed on May 10, 2022.

(51) Int. Cl. H04W 8/20; H04W 8/18; H04W 12/06

(52) U.S. Cl. CPC H04W 8/20; H04W 8/183; H04W 12/06

(57) ABSTRACT

This disclosure relates to configuring a mobile device for mobile network and installing application on a mobile device. In some aspects, a method includes receiving subscriber identity module (SIM) information associated with a SIM card inserted into a mobile device, identifying a wireless service provider associated with the SIM card, launching an application for configuring the mobile device, and configuring the mobile device using the application in accordance with a set of specifications associated with the wireless service provider, wherein the set of specifications are selected by the application from a plurality of sets of specifications, each set of specifications in the plurality of sets of specifications corresponding to a particular wireless service provider.

### CROSS-REFERENCE TO RELATED APPLICATION

This application claims priority to U.S. Pat. Application Serial No. 63/340,221, filed on May 10, 2022, the entirety of which is herby incorporated by reference.

### TECHNICAL FIELD

This specification generally relates to configuring mobile devices to operate on a network associated with a particular wireless service provider.

### BACKGROUND

Mobile devices are typically pre-configured by a manufacturer of the mobile device to operate on a network associated with a particular wireless service provider. Downloading and installing applications on a mobile device are commonly performed manually once the mobile device has been set up.

### SUMMARY

According to one aspect of the subject matter described in this application, a method can include receiving, at one or more processors of a mobile device, subscriber identity module (SIM) information associated with a SIM card of the mobile device, identifying, by the one or more processors based on the SIM information, a wireless service provider associated with the SIM card, launching an application for configuring the mobile device, and configuring the mobile device using the application in accordance with a set of specifications associated with the wireless service provider, wherein the set of specifications are selected by the application from a plurality of sets of specifications, each set of specifications in the plurality of sets of specifications corresponding to a particular wireless service provider.

Implementations according to this aspect can include one or more of the following features. For example, in some implementations, the method can include installing the application on the mobile device based on one or more files stored on the SIM card.

In some implementations, configuring the mobile device can include configuring one or more network parameters for communicating with a radio access network (RAN) associated with the wireless service provider.

In some implementations, the one or more network parameters comprise at least one mobile network operator (MNO) parameter. In some examples, the at least one MNO parameter comprises an access point name (APN) in the RAN of the wireless service provider.

In some implementations, configuring the mobile device can include configuring one or more applications installed on the mobile device in accordance with the set of specifications associated with the wireless service provider.

In some implementations, configuring the mobile device can include installing one or more applications associated with the wireless service provider.

In some implementations, configuring the mobile device can include launching an installer application configured to facilitate installation of one or more other applications on the mobile device.

According to another aspect of the subject matter described in this application, a method can include receiving, by a first application installed on a computing device, a first authorization token from a second application installed on the computing device, storing the first authorization token on a storage device accessible by the computing device, receiving, via an application programming interface (API) of the first application from an API of the second application, instructions to install at least a third application, wherein the instructions to install at least the third application includes a second authorization token, determining that the second authorization token matches the first authorization token, responsive to determining that the second authorization token matches the first authorization token, providing to the first application, the instructions to install at least the third application, and initiating, by the first application, an installation of at least the third application on the computing device.

Implementations according to this aspect can include one or more of the following features. For example, in some implementations, the method can include sending, by the first application to the second application, information indicative of installation of the at least the third application on the computing device.

In some implementations, the method can include validating, by the API of the first application, that the third application is among a set of applications approved for installation on the computing device.

In some implementations, the instructions to install at least the third application are provided to the first application via a fourth application associated with an operating system of the computing device.

In some implementations, storing the first authorization token on the storage device accessible by the computing device can include forwarding the first authorization token from the first application to the storage device via the API of the first application.

According to another aspect of the subject matter described in this application, a non-transitory computer-readable medium encoded with instructions that, when executed by one or more computers, cause the one or more computers to perform operations including receiving, at one or more processors of a mobile device, subscriber identity module (SIM) information associated with a SIM card inserted into the mobile device, identifying, by the one or more processors based on the SIM information, a wireless service provider associated with the SIM card, launching an application for configuring the mobile device, and configuring the mobile device using the application in accordance with a set of specifications associated with the wireless service provider, wherein the set of specifications are selected by the application from a plurality of sets of specifications, each set of specifications in the plurality of sets of specifications corresponding to a particular wireless service provider.

Implementations according to this aspect can include one or more of the following features. For example, in some implementations, the operations can include installing the application on the mobile device based on one or more files stored on the SIM card.

In some implementations, configuring the mobile device comprises operations of configuring one or more network parameters for communicating with a radio access network (RAN) associated with the wireless service provider.

In some implementations, the one or more network parameters comprise at least one mobile network operator (MNO) parameter.

In some implementations, the at least one MNO parameter comprises an access point name (APN) in the RAN of the wireless service provider.

In some implementations, configuring the mobile device comprises operations of configuring one or more applications installed on the mobile device in accordance with the set of specifications associated with the identified wireless service provider.

In some implementations, configuring the mobile device comprises operations of installing one or more applications associated with the wireless service provider.

In some implementations, configuring the mobile device comprises operations of launching an installer application configured to facilitate installation of one or more other applications on the mobile device.

According to another aspect of the subject matter described in this application, a non-transitory computer-readable medium encoded with instructions that, when executed by one or more computers, cause the one or more computers to perform operations including receiving, by a first application installed on a computing device, a first authorization token from a second application installed on the computing device, storing the first authorization token on a storage device accessible by the computing device, receiving, via an application programming interface (API) of the first application from an API of the second application, instructions to install at least a third application, wherein the instructions to install at least the third application includes a second authorization token, determining that the second authorization token matches the first authorization token, responsive to determining that the second authorization token matches the first authorization token, providing to the first application, the instructions to install at least the third application, and initiating, by the first application, an installation of at least the third application on the computing device.

Implementations according to this aspect can include one or more of the following features. For example, in some implementations, operations can include sending, by the first application to the second application, information indicative of installation of the at least the third application on the computing device.

In some implementations, the operations can include validating, by the API of the first application, that the third application is among a set of applications approved for installation on the computing device.

In some implementations, the instructions to install at least the third application are provided to the first application via a fourth application associated with an operating system of the computing device.

In some implementations, storing the first authorization token on the storage device accessible by the computing device can include operations of forwarding the first authorization token from the first application to the storage device via the API of the first application.

According to another aspect of the subject matter described in this application, a system comprising one or more computers and one or more storage devices on which are stored instructions that are operable, when executed by the one or more computers, to cause the one or more computers to perform operations including receiving, at one or more processors of a mobile device, subscriber identity module (SIM) information associated with a SIM card of the mobile device, identifying, by the one or more processors based on the SIM information, a wireless service provider associated with the SIM card, launching an application for configuring the mobile device, and configuring the mobile device using the application in accordance with a set of specifications associated with the wireless service provider, wherein the set of specifications are selected by the application from a plurality of sets of specifications, each set of specifications in the plurality of sets of specifications corresponding to a particular wireless service provider.

According to another aspect of the subject matter described in this application, a system comprising one or more computers and one or more storage devices on which are stored instructions that are operable, when executed by the one or more computers, to cause the one or more computers to perform operations including receiving, by a first application installed on a computing device, a first authorization token from a second application installed on the computing device, storing the first authorization token on a storage device accessible by the computing device, receiving, via an application programming interface (API) of the first application from an API of the second application, instructions to install at least a third application, wherein the instructions to install at least the third application includes a second authorization token, determining that the second authorization token matches the first authorization token, responsive to determining that the second authorization token matches the first authorization token, providing to the first application, the instructions to install at least the third application, and initiating, by the first application, an installation of at least the third application on the computing device. It is appreciated that methods and systems in accordance with the present disclosure can include any combination of the aspects and features described herein. That is, methods and systems in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is a flowchart of an example process for configuring a mobile device based on a SIM card inserted into the mobile device.

FIG. 2 is a flowchart of an example process for configuring a mobile device.

FIG. 3 is a schematic diagram illustrating example interactions between an installer application and a repository of a partner application for installing the partner application onto a mobile device.

FIG. 4 is a block diagram of an example environment for installing a partner application onto a mobile device using an application installer in accordance with technology described herein.

FIG. 5 is a flowchart of an example process for installing applications onto a mobile device in accordance with technology described herein.

FIGS. 6A and 6B are example user interfaces provided by an installer application in accordance with technology described herein.

FIG. 7 shows examples of computing devices, including a mobile device.

### DETAILED DESCRIPTION

This document describes technology that facilitates customization of a mobile device in accordance with a wireless service provider associated with a SIM card of the mobile device. Specifically, the wireless service provider can be identified based on reading information stored on the SIM card, and a configurator application can be launched to configure/customize the mobile device in accordance with the specifications of the particular wireless service provider. This can include, for example, configuring network access parameters, configuring/customizing pre-installed applications, and assigning/customizing privileges associated with particular applications. In some implementations, this can include provisioning an electronic SIM (eSIM) stored on an embedded universal integrated circuit card (eUICC) chip. In some cases, configuring/customizing the mobile device can include launching an installer application that facilitates automatic installation of multiple other applications on the mobile device without substantial user-intervention (except possibly user-selection of the applications to be installed).

By providing a configurator application that is capable of configuring/customizing a mobile device for multiple wireless service providers, manufacturing of mobile devices can be made substantially independent of particular specifications of individual wireless service providers (also referred to as carriers). This can facilitate efficient production of mobile devices by reducing coordination that may otherwise be needed between the manufacturer of the mobile device and the individual wireless service providers. This can also facilitate mobile devices being offered separately from the SIM cards, thereby allowing users to choose devices and wireless service providers independently.

By providing the installer application, the technology described herein can allow users to choose multiple applications for installation on a mobile device without further user-intervention. In some cases, this can result in superior user-experience and easy customization of a newly acquired mobile device. By incorporating an authorization token based interaction between application programming interfaces (APIs) of two separate applications, the technology allows for instructions to be exchanged between two applications even on platforms and operating systems that do not allow direct communications between multiple third-party applications.

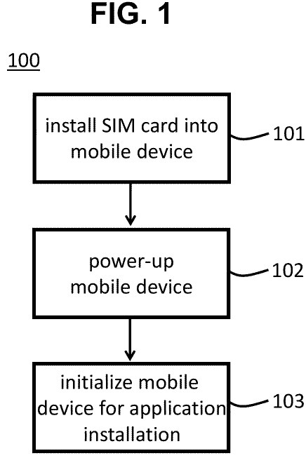

FIG. 1 is a flowchart of an example process 100 for configuring a mobile device based on a SIM card inserted into the mobile device. The steps for configuring the mobile device can include inserting a SIM card into the mobile device for the first time. Upon inserting a SIM card into a mobile device (step 101), and powering-up the mobile device (step 102), the mobile device can enter into a configuration mode where the mobile device is configured in accordance with specifications of the wireless service provider associated with SIM card (step 103). Such a configuration process obviates the need for devices to be pre-configured for particular wireless service providers by the device manufacturers, thereby potentially streamlining the device manufacture process. In addition, such a configuration process allows users to select devices and wireless service providers independently of one another, thereby offering users more choices. In some implementations, configuring the mobile device can include initializing installation of particular applications (e.g., applications specific to the particular wireless service provider) onto the mobile device.

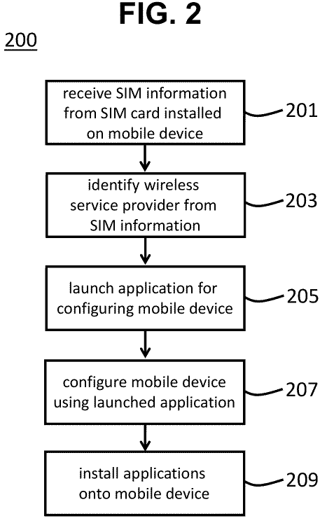

FIG. 2 is a flowchart of one example process 200 for configuring a mobile device. At least a portion of the process 200 can be executed, for example, at one or more processors of a mobile device. Operations of the process 200 can include receiving, at the one or more processors of the mobile device, SIM information associated with a SIM card of the mobile device (201). The SIM information can include, for example, information identifying the SIM card and/or information identifying a wireless service provider associated with the SIM card. In some implementations, a configurator application is installed and launched during the initialization of the configuration process 100 - wherein the configuration application is programmed to retrieve the SIM information. In some implementations, the configuration application may be launched later, for example, after a wireless service provider is identified based on the SIM information.

Operations of the process 200 can also include identifying, based on the SIM information, the wireless service provider associated with the SIM card (203). Operations of the process can also include launching an application (e.g., the configuration application) for configuring the mobile device (205). In some implementations, a file package associated with the configuration application may be retrieved from the SIM card and executed to install and launch the configurator application. In some implementations, the configurator application may be pre-installed on the mobile device, and launched therefrom. In some implementations, the configurator application may be a universal application that is used to configure the mobile device for multiple wireless service providers. In some implementations, the configurator application can be brand-specific with respect to a manufacturer of the wireless service provider.

Operations of the process 200 also includes configuring the mobile device using the application in accordance with a set of specifications associated with the identified wireless service provider (207). If a universal configurator application is provided, the set of specifications can be selected by the application from multiple sets of specifications, each set of specifications corresponding to a particular wireless service provider. Configuring the mobile device can include, for example, configuring one or more network parameters for communicating with a radio access network (RAN) associated with the wireless service provider. For example, at least one MNO parameter such as an access point name (APN) in the RAN of the wireless service provider can be automatically provided in the settings as a part of the customization process. In some implementations, the contact information for the wireless service provider, as well as the customer identification information, are automatically added as contacts to a contact list stored on the mobile device. In some implementations, the mobile device can be configured to display a wallpaper specific to the wireless service provider. In some implementations, configuring the mobile device can include incorporating account-specific settings, such as disabling of social media applications for government and enterprise accounts.

In some implementations, configuring the mobile device can include configuring one or more applications installed on the mobile device in accordance with the set of specifications associated with the identified wireless service provider. This can include, for example, automatically downloading and installing a set of applications associated with the wireless service providers. Examples include an application for accessing user account associated with the wireless service provider and an application for accessing customer service associated with the wireless service provider. In some implementations, configuring the one or more applications may include updating at least some of the applications. For example, if updates are available for any applications, the mobile device can be configured to automatically obtain the updates (for example, from a remote server) and update the application(s).

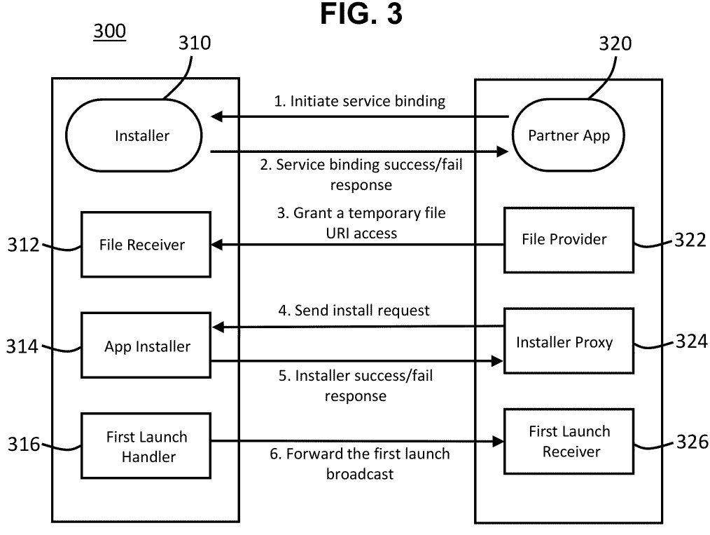

In some implementations, configuring a mobile device can also include launching an installer application that facilitates automatic installation of one or more other applications on the mobile device. This can be done in various ways. FIG. 3 is a schematic diagram 300 illustrating example interactions between an installer application and a repository of a partner application for installing the partner application onto a mobile device. The schematic 300 illustrates an installer 310 and another application (denoted as a partner application 320) that is to be installed on the mobile device. At step 1, upon initialization of the mobile device, the partner application 320 initiates service binding with the installer 310. At step 2, a response is provided from the installer 310 to the partner application 320 whether the service binding initiated by the partner application 320 has been successful or has failed. At step 3, upon the service binding initiated by the partner application 320 having been successful, a file provider 322 of the partner application 320 grants to a temporary file associated with a file receiver 312 of the installer 310 uniform resource identifier (URI) access. At step 4, an installer proxy 324 of the partner application 320 sends an install request to an application installer 314 of the installer 310. At step 5, the application installer 314 sends to the installer proxy 324 an installer response indicating success or failure of application installation. At step 6, upon successful application installation, a first launch handler 316 of the installer 310 forwards a first launch broadcast to a first launch received 326 of the partner application 320.

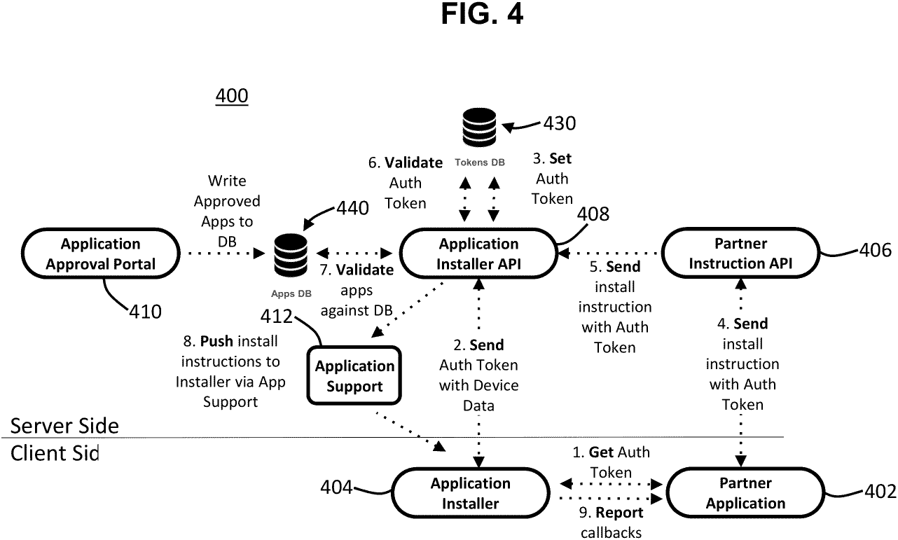

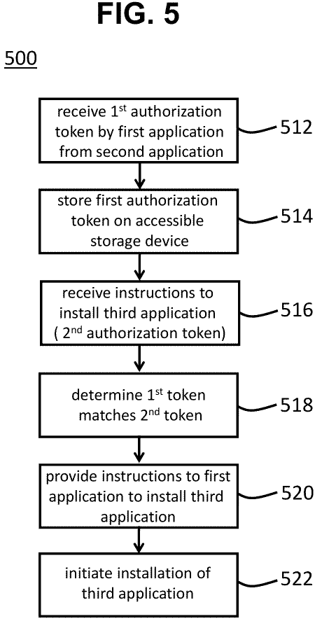

The interactions depicted in FIG. 3 are made possible via direct communications between the installer application 310 and the repository of the partner application 320. However, in some cases, such communications may be constrained (or not permitted) due to regulations imposed by the operating system and/or the repository platform of the partner application. FIG. 4 is a block diagram of an example environment for installing a partner application onto a mobile device via an alternative process. A client-side 401 of the environment 400 includes a partner application 402 and an application installer 404. The server side includes a partner instruction application programming interface (API) 406, an application installer API 408, an application approval portal 410, and a provider of application support 412. In some implementations, a token-based authorization process facilitated via communications between the APIs can be used to install a partner application onto a mobile device. For example, at step 1, the partner application 402 obtains an authorization token from the application installer 404. At step 2, the application installer 404 sends a token authorization along with device data associated with the mobile device upon which the partner application 402 is intends to install applications to the application installer API 408. At step 3, the token authorization is set or stored in a tokens database 430. At step 4, the partner application 402 sends installation instructions with along with the authorization token obtained from the application installer 404 in step1 to the partner instruction API 406. At step 5, the partner instruction API 406 sends the installation instructions with the authorization token to the application installer API 408. At step 6, the authorization token is validated based upon the tokens database 430. At step 7, the partner application 402 intended to be installed on the mobile device is submitted by the application installer API 408 to an applications database 440 for validation based upon comparison with an applications database 440, which stores approved applications for installation and is maintained by the application approval portal 410. The validation of the partner application 402 is returned to the application installer API 408. At step 8, installation instructions is sent from the application installer API 408 to the application installer 404 through a provider of application support 412. At step 9, the application installer 404 provides a report back to the partner application 402 that installation of the application has been installed onto the mobile device. This process is described further with reference to FIG. 5, which shows a flowchart of an example process for installing applications onto a mobile device in accordance with technology described herein.

The operations of the process 500 includes multiple steps or operations. At step 512, a first authorization token is received by a first application installed on a mobile device. The first authorization token is received from a second application installed on the mobile device. An example of the first application can be the installer application described herein, and an example of the second application can be a partner application that facilitates installation of multiple third party applications on the mobile device.

At step 514, the first authorization token is stored on a storage device accessible by the mobile device. In some implementations, the first authorization token may be stored on a storage device of the mobile device, or may be stored remotely on the cloud. At step 516, instructions to install at least a third application onto the mobile device are received. The instructions may be received from an application programming interface (API) of the first application from an API of the second application. In situations where direct communications between two applications are not permitted (e.g., due to regulatory restrictions imposed by an operating system and/or a repository of the applications), such inter-API communications may be used to exchange information between the applications. The instructions to install at least the third application includes a second authorization token.

At step 518, a determination is made whether the authorization token received from Partner API Server matches the authorization token received from device, and upon determining a match, at step 520, instructions are provided to the first application to install the third application. The third application can be one of the applications that are approved to be installed on the mobile device (e.g., applications stored in the database 440 described above with reference to FIG. 4).

At step 522, the first application initiates installation of at least the third application onto the mobile device. This can be done, for example, by providing instructions to the first application via a fourth application associated with an operating system of the computing device. In some implementations, the fourth application can be the application support module 412 described above with reference to FIG. 4.

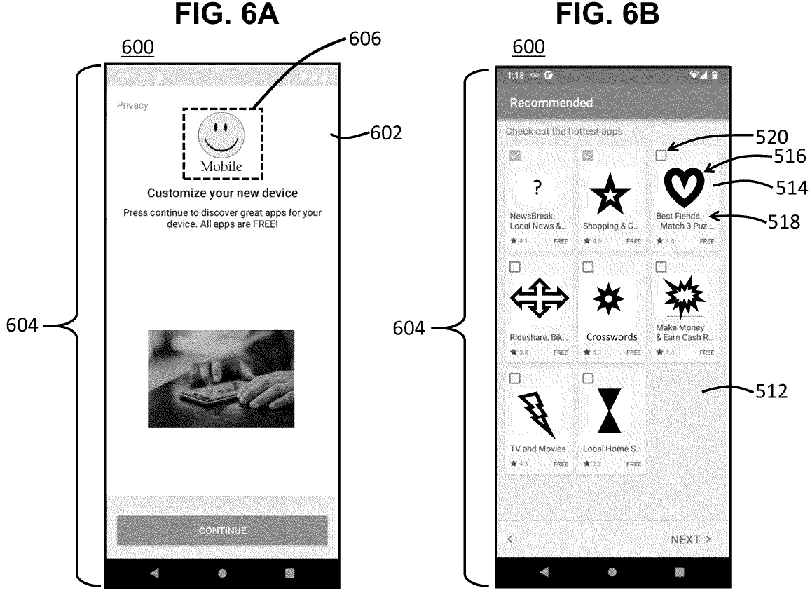

FIGS. 6A and 6B are example user interfaces provided by an installer application in accordance with technology described herein. Prior to receiving instructions to install applications onto the mobile device, a user interface 602 can be presented on a display 604 of the mobile device 600 indicating that the mobile device 600 can be customized based upon installing one or more additional applications (e.g., third party applications or applications specific to the wireless service provider). In FIG. 6A, the user interface may be brand-specific with respect to the wireless service provider and include an indicator 606 that shows a logo and/or a written description, of the wireless service provider. In some implementations, the user-interface 602 may provide information regarding one or more of the partner applications. For example, the user-interface 602 may advertise that one or more third party applications are available to be installed on the mobile device 600.

Upon receiving user-input to continue with the customization process, the mobile device 600 may display the user interface 612 to show the available options. For example, as shown in FIG. 6B, the user interface 612 can display one or more icons 614, each associated with an available third-party application. Each icon 614 can include for example, a logo or symbol 616, a written description 618 representative of the associated partner application, and a selection box 620. The user interface 612 affords an opportunity to select one or more of the partner applications for installation onto the mobile device.

In some implementations, selecting one or more of the partner applications for installation onto the mobile device may be additive or subtractive. For example, each of the third party applications may be individually shown on the selection user interface 612 and individually selected for installation onto the mobile device by clicking on the selection box 620 corresponding to the particular partner application, or the user may have the option to deselect the selection box 620 for each partner application shown in the selection user interface 612 that it not desired for installation onto the mobile device. Selection of the third party application can initiate a process (e.g., the process 500 described with reference to FIG. 5) for automatically installing the selected applications on the mobile device.

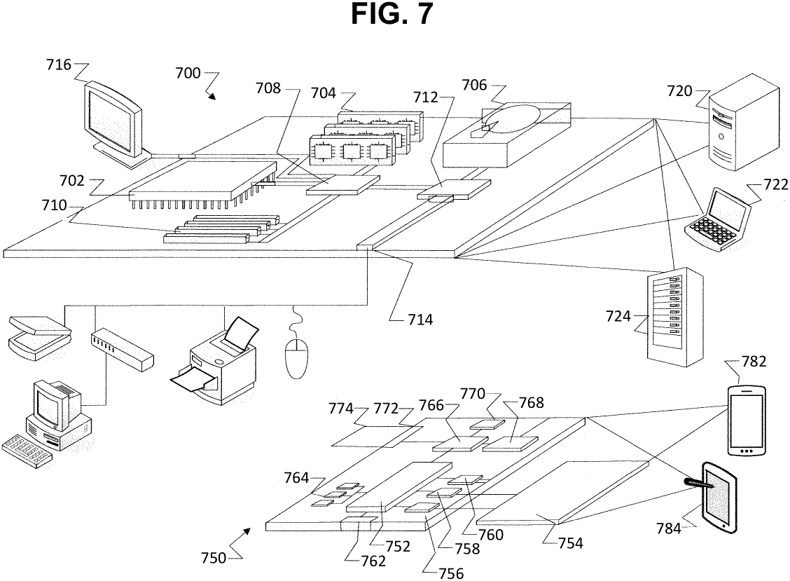

FIG. 7 shows an example of a computing device 700 and a mobile computing device 750 (also referred to herein as a wireless device) that are employed to execute implementations of the present disclosure. The computing device 700 is intended to represent various forms of digital computers, such as laptops, desktops, workstations, personal digital assistants, servers, blade servers, mainframes, and other appropriate computers. The mobile computing device 750 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 700 and/or the mobile computing device 750 can form at least a portion of the application installation environment described above.

The computing device 700 includes a processor 702, a memory 704, a storage device 706, a high-speed interface 708, and a low-speed interface 712. In some implementations, the high-speed interface 708 connects to the memory 704 and multiple high-speed expansion ports 710. In some implementations, the low-speed interface 712 connects to a low-speed expansion port 714 and the storage device 706. Each of the processor 702, the memory 704, the storage device 706, the high-speed interface 708, the high-speed expansion ports 710, and the low-speed interface 712, are interconnected using various buses, and may be mounted on a common motherboard or in other manners as appropriate. The processor 702 can process instructions for execution within the computing device 700, including instructions stored in the memory 704 and/or on the storage device 706 to display graphical information for a graphical user interface (GUI) on an external input/output device, such as a display 716 coupled to the high-speed interface 708. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of a computer-readable medium, such as a magnetic or optical disk.

The storage device 706 is capable of providing mass storage for the computing device 700. In some implementations, the storage device 706 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 702, perform one or more methods, such as those described above. The instructions can also be stored by one or more storage devices, such as computer-readable or machine-readable mediums, such as the memory 704, the storage device 706, or memory on the processor 702.

The high-speed interface 708 manages bandwidth-intensive operations for the computing device 700, while the low-speed interface 712 manages lower bandwidth-intensive operations. Such allocation of functions is an example only. In some implementations, the high-speed interface 708 is coupled to the memory 704, the display 716 (e.g., through a graphics processor or accelerator), and to the high-speed expansion ports 710, which may accept various expansion cards. In the implementation, the low-speed interface 712 is coupled to the storage device 706 and the low-speed expansion port 714. The low-speed expansion port 714, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 714 through a network adapter. Such network input/output devices may include, for example, a switch or router.

The computing device 700 may be implemented in a number of different forms, as shown in the FIG. 7. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device, such as a mobile computing device 750. Each of such devices may contain one or more of the computing device 700 and the mobile computing device 750, and an entire system may be made up of multiple computing devices communicating with each other.

The mobile computing device 750 includes a processor 752; a memory 764; an input/output device, such as a display 754; a communication interface 766; and a transceiver 768; among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate. In some implementations, the mobile computing device 750 may include a camera device(s) (not shown).

The processor 752 can execute instructions within the mobile computing device 750, including instructions stored in the memory 764. The processor 752 may be implemented as a chipset of chips that include separate and multiple analog and digital processors. For example, the processor 752 may be a Complex Instruction Set Computers (CISC) processor, a Reduced Instruction Set Computer (RISC) processor, or a Minimal Instruction Set Computer (MISC) processor. The processor 752 may provide, for example, for coordination of the other components of the mobile computing device 750, such as control of user interfaces (UIs), applications run by the mobile computing device 750, and/or wireless communication by the mobile computing device 750.

The processor 752 may communicate with a user through a control interface 758 and a display interface 756 coupled to the display 754. The display 754 may be, for example, a Thin-Film-Transistor Liquid Crystal Display (TFT) display, an Organic Light Emitting Diode (OLED) display, or other appropriate display technology. The display interface 756 may include appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a Single in Line Memory Module (SIMM) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provided as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 752, perform one or more methods, such as those described above. The instructions can also be stored by one or more storage devices, such as one or more computer-readable or machine-readable mediums, such as the memory 764, the expansion memory 774, or memory on the processor 752. In some implementations, the instructions can be received in a propagated signal, such as, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 768 using a radio frequency. In addition, short-range communication, such as using a Bluetooth or Wi-Fi, may occur. In addition, a Global Positioning System (GPS) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in FIG. 7. For example, it may be implemented in the mobile device described with respect to FIGS. 1-6. Other implementations may include a phone device 782 and a tablet device 784. The mobile computing device 750 may also be implemented as a component of a smart-phone, personal digital assistant, AR device, or other similar mobile device.

Computing device 700 and/or 750 can also include USB flash drives. The USB flash drives may store operating systems and other applications. The USB flash drives can include input/output components, such as a wireless transmitter or USB connector that may be inserted into a USB port of another computing device.

Although a few implementations have been described in detail above, other modifications may be made without departing from the scope of the inventive concepts described herein, and, accordingly, other implementations are within the scope of the following claims.

1. A computer-implemented method comprising:
receiving, at one or more processors of a mobile device, subscriber identity module (SIM) information associated with a SIM card of the mobile device;
identifying, by the one or more processors based on the SIM information, a wireless service provider associated with the SIM card;
launching an application for configuring the mobile device; and
configuring the mobile device using the application in accordance with a set of specifications associated with the wireless service provider, wherein the set of specifications are selected by the application from a plurality of sets of specifications, each set of specifications in the plurality of sets of specifications corresponding to a particular wireless service provider.

2. The method of claim 1, further comprising installing the application on the mobile device based on one or more files stored on the SIM card.

3. The method of claim 1, wherein configuring the mobile device comprises configuring one or more network parameters for communicating with a radio access network (RAN) associated with the wireless service provider.

4. The method of claim 3, wherein the one or more network parameters comprise at least one mobile network operator (MNO) parameter.

5. The method of claim 4, wherein the at least one MNO parameter comprises an access point name (APN) in the RAN of the wireless service provider.

6. The method of claim 1, wherein configuring the mobile device comprises configuring one or more applications installed on the mobile device in accordance with the set of specifications associated with the wireless service provider.

7. The method of claim 1, wherein configuring the mobile device comprises installing one or more applications associated with the wireless service provider.

8. The method of claim 1, wherein configuring the mobile device comprises launching an installer application configured to facilitate installation of one or more other applications on the mobile device.

9-13. (canceled)

14. A non-transitory computer-readable medium encoded with instructions that, when executed by one or more computers, cause the one or more computers to perform operations comprising:
receiving, at one or more processors of a mobile device, subscriber identity module (SIM) information associated with a SIM card inserted into the mobile device;
identifying, by the one or more processors based on the SIM information, a wireless service provider associated with the SIM card;
launching an application for configuring the mobile device; and
configuring the mobile device using the application in accordance with a set of specifications associated with the wireless service provider, wherein the set of specifications are selected by the application from a plurality of sets of specifications, each set of specifications in the plurality of sets of specifications corresponding to a particular wireless service provider.

15. The non-transitory computer-readable medium of claim 14, further comprising operations of installing the application on the mobile device based on one or more files stored on the SIM card.

16. The non-transitory computer-readable medium of claim 14, wherein configuring the mobile device comprises operations of configuring one or more network parameters for communicating with a radio access network (RAN) associated with the wireless service provider.

17. The non-transitory computer-readable medium of claim 16, wherein the one or more network parameters comprise at least one mobile network operator (MNO) parameter.

18. The non-transitory computer-readable medium of claim 17, wherein the at least one MNO parameter comprises an access point name (APN) in the RAN of the wireless service provider.

19. The non-transitory computer-readable medium of claim 14, wherein configuring the mobile device comprises operations of configuring one or more applications installed on the mobile device in accordance with the set of specifications associated with the wireless service provider.

20. The non-transitory computer-readable medium of claim 14, wherein configuring the mobile device comprises operations of installing one or more applications associated with the wireless service provider.

21. The non-transitory computer-readable medium of claim 14, wherein configuring the mobile device comprises operations of launching an installer application configured to facilitate installation of one or more other applications on the mobile device.

22-26. (canceled)

27. A system comprising one or more computers and one or more storage devices on which are stored instructions that are operable, when executed by the one or more computers, to cause the one or more computers to perform operations comprising:
receiving, at one or more processors of a mobile device, subscriber identity module (SIM) information associated with a SIM card of the mobile device;
identifying, by the one or more processors based on the SIM information, a wireless service provider associated with the SIM card;
launching an application for configuring the mobile device; and
configuring the mobile device using the application in accordance with a set of specifications associated with the wireless service provider, wherein the set of specifications are selected by the application from a plurality of sets of specifications, each set of specifications in the plurality of sets of specifications corresponding to a particular wireless service provider.

28. (canceled)

29. The system of claim 27, wherein the operations further comprise installing the application on the mobile device based on one or more files stored on the SIM card.

30. The system of claim 27, wherein configuring the mobile device comprises operations of configuring one or more network parameters for communicating with a radio access network (RAN) associated with the wireless service provider.

31. The system of claim 27, wherein configuring the mobile device comprises operations of configuring one or more applications installed on the mobile device in accordance with the set of specifications associated with the wireless service provider.
